(19) United States
(12) Patent Application Publication
(10) Pub. No.: US 2014/0179294 A1
(43) Pub. Date: Jun. 26, 2014

(54) ELECTRONIC DEVICE AND METHOD FOR TRANSFERRING COMMUNICATION SESSION

(71) Applicant: Chiun Mai Communication Systems, Inc., New Taipei (TW)

(72) Inventor: WEN-LUNG LIU, New Taipei (TW)

(73) Assignee: CHIUN MAI COMMUNICATION SYSTEMS, INC., New Taipei (TW)

(21) Appl. No.: 14/108,401

(22) Filed: Dec. 17, 2013

(30) Foreign Application Priority Data
Dec. 21, 2012 (TW) 101148895

(51) Int. Cl. H04W 4/16; H04M 3/54

(52) U.S. Cl. CPC H04W 4/16; H04M 3/54
USPC 455/417

(57) ABSTRACT

In a method for transferring communication sessions between a first and a second electronic devices, an incoming call message is sent to the second electronic device when the first electronic device receives an incoming call. The first electronic device answers the incoming call when receiving an agreed response signal from the second electronic device. Audio/video data is transmitted between the second electronic device and a caller of the incoming call through the first electronic device. The first electronic device terminates the incoming call when the caller hangs up the incoming call, or when receiving a termination command from the second electronic device.

### BACKGROUND

1. Technical Field

Embodiments of the present disclosure relate to communication technology, and particularly to an electronic device and a method for transferring communication session between devices.

2. Description of Related Art

A user can use a communication device (e.g., a mobile phone) to communicate with other people. However, the communication device should have a subscriber identity module (SIM) card that stores the international mobile subscriber identity (IMSI) to identify and authenticate subscribers of the communication device. When an electronic device has no SIM card, the electronic device cannot use a communication service provided by the subscribers. For example, a personal digital assistant without a SIM card cannot be used to dial a phone call based on the Global System for Mobile Communications (GSM) network or the Code division multiple access (CDMA) network. Therefore, an improved method for transferring communication session between devices is desired.

### BRIEF DESCRIPTION OF THE DRAWINGS

FIG. 1 is a block diagram of one embodiment of a connection between a first electronic device and a second electronic device.

FIG. 2 is a block diagram of one embodiment of the first electronic device including a communication transfer system.

FIG. 3 is a flowchart of one embodiment of a method for transferring communication session using the communication transfer system in the first electronic device.

FIG. 4 is a flowchart of one embodiment of a method for transferring communication session using the communication transfer system in the second electronic device.

### DETAILED DESCRIPTION

All of the processes described below may be embodied in, and fully automated via, functional code modules executed by one or more general purpose electronic devices or processors. The code modules may be stored in any type of non-transitory computer-readable medium or other storage device. Some or all of the methods may alternatively be embodied in specialized hardware. Depending on the embodiment, the non-transitory computer-readable medium may be a hard disk drive, a compact disc, a digital video disc, a tape drive or other suitable storage medium.

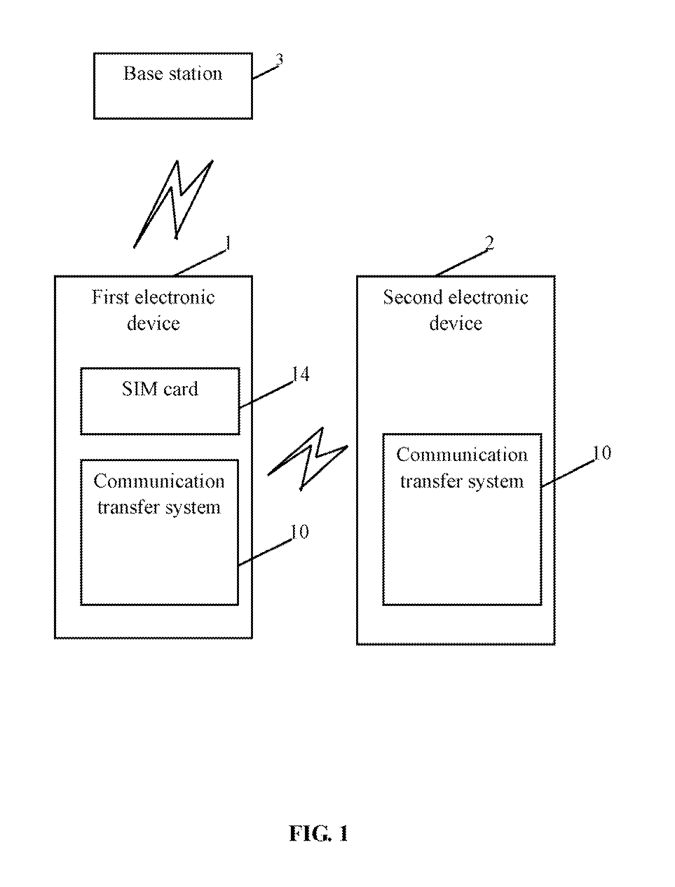

FIG. 1 is a block diagram of one embodiment of a connection between a first electronic device 1 and a second electronic device 2. The first electronic device 1 is a communication device having a subscriber identity module (SIM) card 14, such as a mobile phone, for example. The first electronic device 1 may be connected to a base station 3 so as to achieve communication with other communication devices. The first electronic device 1 is further connected to the second electronic device 2 through a wired or a wireless connection, such as RJ-45, Wi-Fi, BLUETOOTH, for example. The connection can also be through an intranet or the Internet. The second electronic device 2 may have or not have a SIM card. In some embodiments, the second electronic device 2 may be a tablet computer, a personal digital assistant, a notebook computer, or any other computing device.

In some embodiments, the first electronic device 1 is regarded as a master electronic device, and the second electronic device 2 is regarded as a slave electronic device. The first electronic device 1 may be connected to a plurality of second electronic devices 2, also each of the second electronic devices 2 may be connected to a plurality of first electronic devices 1. For simplification, only one first electronic device 1 and one second electronic device 2 are shown in FIG. 1.

In some embodiments, the communication transfer system 10 may be included in both of the first electronic device 1 and the second electronic device 2 to transfer one or more communication sessions between the first electronic device 1 and the second electronic device 2. The communication transfer system 10 is used to notify an incoming call for the second electronic device 2 when the first electronic device 1 receives the incoming call from a caller, and transmit audio data and/or video data between the second electronic device 2 and the caller when the incoming call is answered.

The communication transfer system 10 is further used to control the first electronic device 1 to dial an outgoing call by the second electronic device 2, and transmit incoming messages from the first electronic device 1 to the second electronic device 2, and transmit outgoing messages from the second electronic device 2 to the first electronic device 1. By utilizing the communication transfer system 10, the first electronic device 1 may transfer communication sessions and messages to the second electronic device 2.

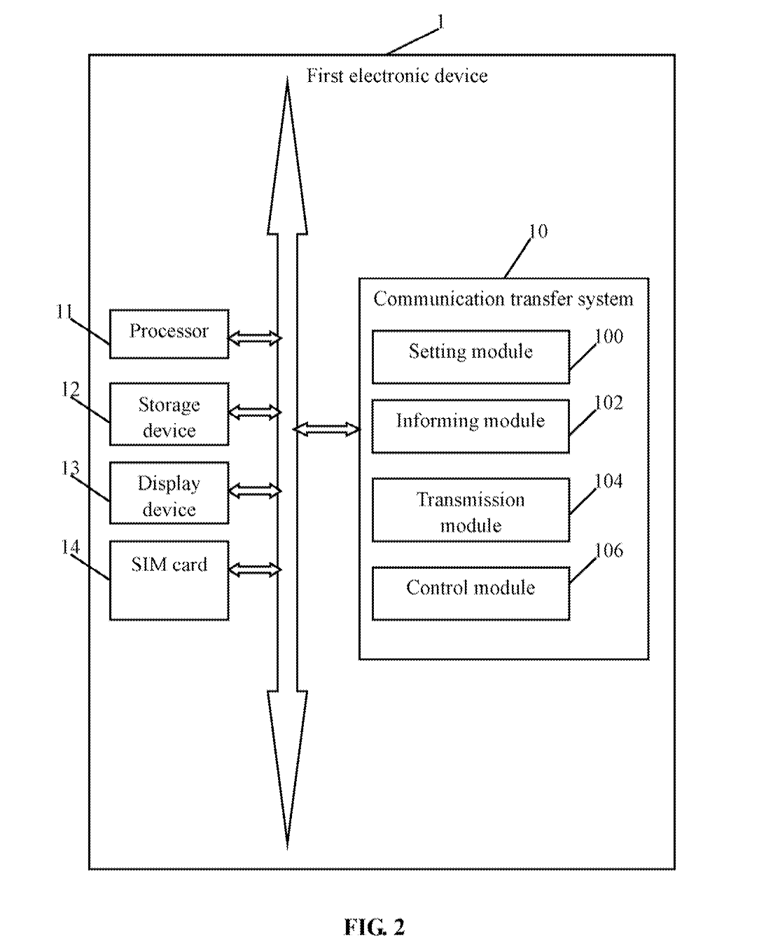

FIG. 2 is a block diagram of one embodiment of the first electronic device 1 including the communication transfer system 10. The electronic device 1 includes at least one processor 11, a storage device 12, a display device 13, and the SIM card 14. In other embodiments, the electronic device 1 can include more or fewer components than illustrated, or have a different configuration of the various components.

The at least one processor 11 is used to execute the communication transfer system 10 and other applications, such as an operating system, installed in the electronic device 1. The storage devices 12 store one or more programs, such as the operating system and applications of the electronic device 1. The storage device 12 can be a storage card, such as a memory stick, a smart media card, a compact flash card, a secure digital card, or any other type of memory storage device. The display device 13 displays visible data, such as videos, images, for example.

As mentioned above, the communication transfer system 10 can be applied in both of the first electronic device 1 and the second electronic device 2. The communication transfer system 10 may include computerized instructions in the form of one or more programs that are executed by the at least one processor 11 and stored in one or more of the storage devices 12. In one embodiment, the communication transfer system 10 includes one or more modules, for example, a setting module 100, an informing module 102, a transmission module 104, and a control module 106. In general, the word “module,” as used herein, refers to logic embodied in hardware or firmware, or to a collection of software instructions, written in a programming language, such as, JAVA, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable medium include CDs, DVDs, BLU-RAY, flash memory, and hard disk drives.

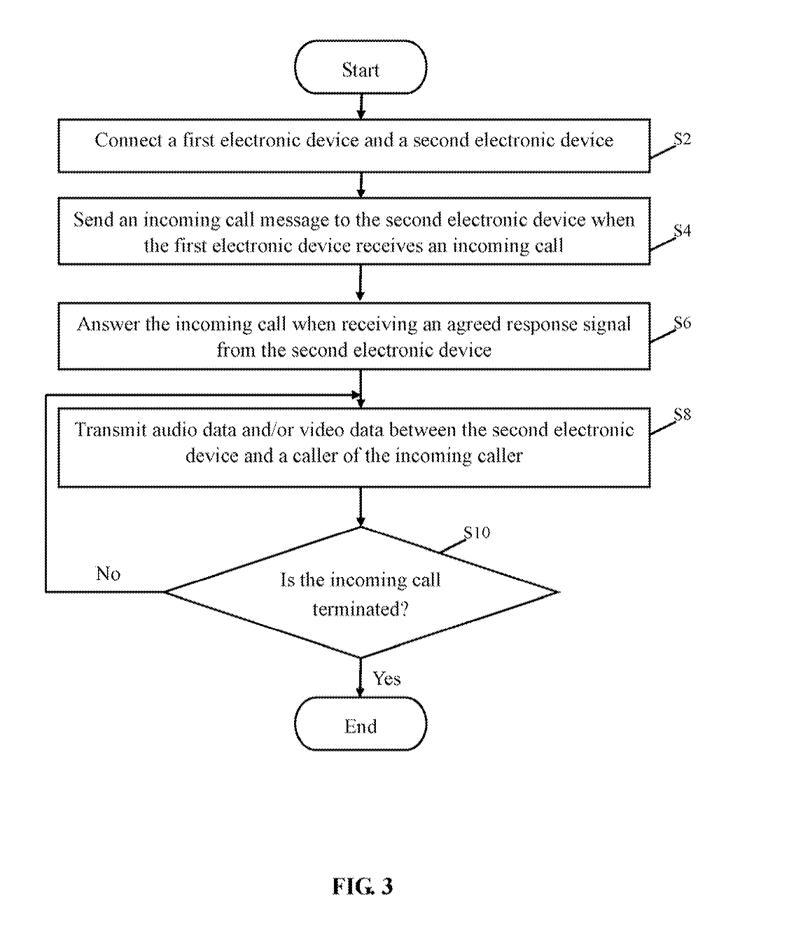

FIG. 3 is a flowchart of one embodiment of a method for transferring communication session using the communication transfer system 10 in the first electronic device 1. Depending on the embodiment, additional steps may be added, others removed, and the ordering of the steps may be changed.

Before the communication transfer system 10 is utilized, the setting module 100 presets a plurality transfer parameters, which can be recognized by the first electronic device 1 and the second electronic device 2. The transfer parameters may include, but are not limited to an incoming call message, an agreed response signal, a termination command, a termination message, a dialing command. The functions of the transfer parameters are provided below.

In step S2, the first electronic device 1 is connected to the second electronic device 2 through the data cable or the wireless connection as mentioned above. The communication transfer system 10 can be started/invoked when a connection between the first electronic device 1 and the second electronic device 2 is established successfully.

In step S4, the informing module 102 sends the incoming call message to the second electronic device 2 when the first electronic device 1 receives an incoming call. The incoming call message is used to invoke the preset indication means in the second electronic device 2. The preset indication means may include outputting preset ringtones, displaying preset information and/or vibrating.

In other embodiments, the communication transfer system 10 may determine phone indication means applied in the first electronic device 1, and then preset indication means in the second electronic device 2 according to the phone indication means in the first electronic device 1.

When the second electronic device 2 receives the incoming call message, the informing module 102 in the second electronic device 2 invokes the preset indication means. Then a user of the second electronic device 2 is notified that the incoming call is received by the first electronic device 1, and the user can make a decision on whether to answer the incoming call or not.

When the user decides to hang up the incoming call, the user may press a preset termination key on the second electronic device 2, then a termination command is generated and sent from the second electronic device 2 to the first electronic device 1. The termination command is used to control the first electronic device 1 to terminate the incoming call.

When the user decides to answer the incoming call, the user may press a preset start key on the second electronic device 2, then an agreed response signal is generated and sent from the second electronic device 2 to the first electronic device 1. When the start key is pressed, it is represented that the user decides to answer the incoming call, or wants to dial an outgoing call. The agreed response signal represents that the user agrees to answer the incoming call. The preset start key and the preset termination key may be any keystroke (e.g., a physical keystroke or a virtual keystroke) or icon on the second electronic device 2.

In step S6, when the first electronic device 1 receives the agreed response signal from the second electronic device 2, the control module 106 establishes a communication between the first electronic device 1 and a caller of the incoming call by answering the incoming call.

In step S8, the transmission module 104 transmits audio data and/or video data between the second electronic device 2 and the caller of the incoming call. In detail, the transmission module 104 transmits received audio signals and/or received video signals detected by the first electronic device 1 to the second electronic device 2, and transmits response audio signals and/or response video signals received from the second electronic 2 device to the caller of the incoming call. The first electronic device 1 may use a microphone, a recorder, a camera, or any other components to record the received audio signals and/or received video signals from the caller.

The second electronic device 2 also may use a microphone, a recorder, a camera, or any other components in the second electronic device 2 to record the response audio signals and/or the response video signals, and then transmits the response audio signals and/or the response video signals to the first electronic device 1 by using the transmission module 104 in the second electronic device 2. Then the transmission module 104 in the first electronic device 1 transmits the response audio signals and/or the response video signals to the caller of the incoming call.

In step S10, the control module 106 determines whether the incoming call is terminated. When the incoming call is terminated, the procedure ends. When the incoming call is not terminated, the procedure returns to step S8.

For example, when the caller hangs up the incoming call, the control module 106 terminates the incoming call and sends a termination message from the first electronic device 1 to the second electronic device 2. The termination message is used to notify the user of the second electronic device 2 that the incoming call is terminated. The informing module 102 in the electronic device 2 may output the termination message, which may be an audio message or a text message.

As another example, when the user of the second electronic device 2 presses the termination key to terminate the incoming call, the termination command is generated and sent to the first electronic device 1 using the transmission module 104. The control module 106 in the first electronic device 1 terminates the incoming call by executing the termination command.

The user of the second electronic device 2 and the user of the first electronic device 1 may be a same person to control the two devices. By utilizing the communication transfer system 10, the user may answer the incoming call received by the first electronic device 1 using any electronic device no matter whether the electronic device has a SIM card or not.

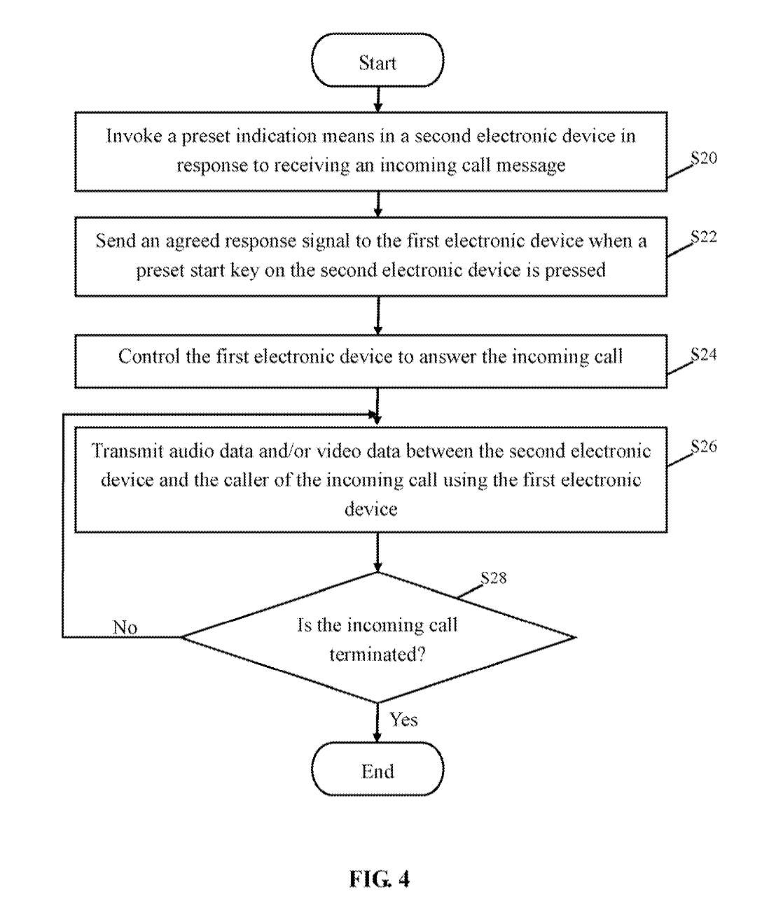

FIG. 4 is a flowchart of one embodiment of a method for transferring communication session using the communication transfer system 10 in the second electronic device 2. Depending on the embodiment, additional steps may be added, others removed, and the ordering of the steps may be changed.

In step S20, the informing module 102 in the second electronic device 2 invokes the preset indication means in the second electronic device 2 when the transmission module 104 receives the incoming call message from the first electronic device 1.

In step S22, the transmission module 104 in the second electronic device 2 sends the agreed response signal from the second electronic device 2 to the first electronic device 1 when the preset start key on the second electronic device 2 is pressed. As mentioned above, the agreed response signal is used to control the first electronic device 1 to answer the incoming call.

In step S24, the control module 106 in the first electronic device 1 establishes the communication between the caller and the second electronic device 2 by answering the incoming call according to the agreed response signal.

In step S26, the transmission module 104 in the second electronic device 2 transmits the audio data and/or the video data between the second electronic device 2 and the caller of the incoming call through the first electronic device 1.

As mentioned above, the transmission module 104 receives the audio signals and/or the video signals from the first electronic device 1, and transmits the response audio signals and/or the response video signals recorded by the second electronic device 2 to the first electronic device 1.

In step S28, the control module 106 in the second electronic device 2 determines whether the incoming call is terminated. When the incoming call is terminated, the procedure ends. When the incoming call is not terminated, the procedure returns to step S26. The determination of the termination of the incoming call may be referred to the above-mentioned examples.

In other embodiments, the user of the second electronic device 2 may dial a phone number to a callee through the first electronic device 1. In detail, the user presses one or more numeric keys to input a phone number, and then presses the start key to generate a dialing command, which is used to control the first electronic device 1 to dial a phone call. The transmission module 104 in the second electronic device 2 determines a corresponding phone number corresponding to the one or more numeric keys, sends the phone number and the dialing command to the first electronic device 1. The control module 106 in the first electronic device 1 dials an outgoing call according to the phone number and the dialing command.

The transmission modules 104 in both of the first electronic device 1 and second electronic device 2 transmit audio data and/or video data between the second electronic device 2 and a callee of the outgoing call through the first electronic device 1 during the outgoing call.

In other embodiments, the transmission module 104 in the first electronic device 1 transmits incoming messages received by the first electronic device 1 to the second electronic device 2. Furthermore, the transmission module 104 in the second electronic device 1 generates outgoing messages according to inputted data and inputted phone numbers, and transmits the outgoing messages to the first electronic device 1. The transmission module 104 in the first electronic device 1 sends the outgoing message to one or more designated communication devices according to the inputted phone numbers.

It should be emphasized that the above-described embodiments of the present disclosure, particularly, any embodiments, are merely possible examples of implementations, set forth for a clear understanding of the principles of the disclosure. Many variations and modifications may be made to the above-described embodiment(s) of the disclosure without departing substantially from the spirit and principles of the disclosure. All such modifications and variations are intended to be included herein within the scope of this disclosure and the present disclosure is protected by the following claims.

What is claimed is:

1. A computer-implemented method for transferring communication session between a first electronic device and a second electronic device, the method comprising:
sending an incoming call message to the second electronic device when the first electronic device receives an incoming call, the incoming call message invoking a preset indication means in the second electronic device;
answering the incoming call when the first electronic device receives an agreed response signal from the second electronic device;
transmitting audio data and/or video data between the second electronic device and a caller of the incoming call using the first electronic device; and
terminating the incoming call and sending a termination message from the first electronic device to the second electronic device when the caller hangs up the incoming call, the termination message indicating the second electronic device that the incoming call is terminated; or
terminating the incoming call by executing a termination command which is received by the first electronic device from the second electronic device.

2. The method according to claim 1, wherein the step of transmitting audio data and/or video data between the second electronic device and a caller of the incoming call using the first electronic device comprises:
transmitting received audio signals and/or received video signals detected by the first electronic device to the second electronic device; and
transmitting response audio signals and/or response video signals received from the second electronic device to the caller of the incoming call.

3. The method according to claim 1, further comprising:
in response to receiving a phone number and a dialing command from the second electronic device, dialing an outgoing call according to the phone number and the dialing command using the first electronic device; and
transmitting audio data and/or video data between the second electronic device and a callee of the outgoing call.

4. The method according to claim 1, further comprising:
transmitting incoming messages received by the first electronic device to the second electronic device; or
transmitting outgoing messages to one or more designated communication devices from the first electronic device when the first electronic device receives the outgoing messages from the second electronic device.

5. The method according to claim 1, wherein the preset indication means comprises outputting preset ringtones, displaying preset information and/or vibrating.

6. The method according to claim 1, wherein the first electronic device has a subscriber identity module (SIM) card, and the second electronic device has no SIM card.

7. A computer-implemented method for transferring communication session between a first electronic device and a second electronic device, the method comprising:
in response to receiving an incoming call message from the first electronic device, invoking a preset indication means in the second electronic device to notify that an incoming call is received by the first electronic device;
sending an agreed response signal from the second electronic device to the first electronic device when a preset start key on the second electronic device is pressed, the agreed response signal being controlled the first electronic device to answer the incoming call;
transmitting audio data and/or video data between the second electronic device and the caller of the incoming call using the first electronic device; and
in response to detecting that a termination key on the second electronic device has been pressed, sending a termination command to the first electronic device, and controlling the first electronic device to terminate the incoming call by executing the termination command; or
in response to receiving a termination message from the first electronic device, outputting a prompt message to notify that the incoming call is terminated.

8. The method according to claim 7, further comprising:
in response to detecting one or more numeric keys and the start key are pressed, determining a corresponding phone number corresponding to the one or more numeric keys;
sending the phone number and a dialing command to the first electronic device, and controlling the first electronic device to dial an outgoing call according to the phone number and the dialing command; and
transmitting audio data and/or video data between the second electronic device and a callee of the outgoing call using the first electronic device during the outgoing call.

9. The method according to claim 7, wherein the step of transmitting audio data and/or video data between the second electronic device and the caller of the incoming call using the first electronic device comprises:
receiving audio signals and/or video signals from the first electronic device, and transmitting response audio signals and/or response video signals detected by a microphone and a camera of the second electronic device to the first electronic device.

10. The method according to claim 7, further comprising:
receiving incoming messages from the first electronic device; or
transmitting outgoing messages according to inputted data and inputted phone numbers to the first electronic device, and controlling the first electronic device to send the outgoing message to one or more designated communication devices according to the inputted phone numbers.

11. A master electronic device in connection to a slave electronic device, the master electronic device comprising:
at least one processor; and
a plurality of storage devices storing a plurality of instructions, which when executed by the processor, causes the at least one processor to:
send an incoming call message to the slave electronic device when the master electronic device receives an incoming call, the incoming call message invoking a preset indication means in the slave electronic device;
answer the incoming call when the master electronic device receives an agreed response signal from the slave electronic device;
transmit audio data and/or video data between the second electronic device and a caller of the incoming call; and
terminate the incoming call and send a termination message from the master electronic device to the slave electronic device when the caller hangs up the incoming call, the termination message indicating the slave electronic device that the incoming call is terminated; or
terminate the incoming call by executing a termination command which is received by the master electronic device from the slave electronic device.

12. The master electronic device according to claim 11, wherein the at least one processor transmits the audio data and/or the video data between the second electronic device and the caller of the incoming call by:
transmitting received audio signals and/or received video signals detected by the first electronic device to the second electronic device; and
transmitting response audio signals and/or response video signals received from the second electronic device to the caller of the incoming call.

13. The master electronic device according to claim 11, wherein the at least one processor further:
in response to receiving a phone number and a dialing command from the slave electronic device, dials an outgoing call according to the phone number and the dialing command; and
transmits audio data and/or video data between the slave electronic device and a callee of the outgoing call.

14. The master electronic device according to claim 11, wherein the at least one processor further:
transmits incoming messages received by the master electronic device to the slave electronic device; or
transmits outgoing messages to one or more designated communication devices from the master electronic device when the master electronic device receives the outgoing messages from the slave electronic device.

15. The master electronic device according to claim 11, wherein the preset indication means comprises outputting preset ringtones, displaying preset information and/or vibrating.

16. The master electronic device according to claim 11, wherein the master electronic device has a subscriber identity module (SIM) card, and the slave electronic device has no SIM card.

17. The master electronic device according to claim 11, wherein the slave electronic device:
in response to receiving an incoming call message from the master electronic device, invokes a preset indication means in the slave electronic device to notify that an incoming call is received by the master electronic device;
sends an agreed response signal from the slave electronic device to the master electronic device when a preset start key on the slave electronic device is pressed, the agreed response signal being controlled the master electronic device to answer the incoming call;
transmits audio data and/or video data between the second electronic device and the caller of the incoming call using the first electronic device; and
in response to detecting that a termination key on the slave electronic device has been pressed, sends a termination command to the master electronic device, and controls the master electronic device to terminate the incoming call by executing the termination command; or
in response to receiving a termination message from the master electronic device, outputs a prompt message to notify that the incoming call is terminated.
